(19) United States
(12) Patent Application Publication
(10) Pub. No.: US 2025/0086547 A1
(43) Pub. Date: Mar. 13, 2025

(54) COMMUNICATING HUMAN FIELD ACTIVITY REQUESTS TO FIELD OPERATORS

(71) Applicant: HONEYWELL INTERNATIONAL INC., Charlotte, NC (US)

(72) Inventors: Santhosh Puthiyedath, MARKHAM (CA); Steven Huang, Toronto (CA); Nikita Baiborodov, Bucharest (RO); Melville DeSouza, North York (CA); Joris Van Ranst, Mechelen (BE); Jean Jacques Claveau, Toronto (CA); Hao You, Bracknell (GB)

(21) Appl. No.: 18/367,464

(22) Filed: Sep. 13, 2023

(51) Int. Cl. G06Q 10/0633; G05B 19/409; G06Q 10/0631

(52) U.S. Cl. CPC G06Q 10/0633; G05B 19/409; G06Q 10/06311

(57) ABSTRACT

Examples techniques to communicate human field activities (HFA) requests to field operators are described. In an example, an HFA request corresponding to an operation to be performed by a field operator on an equipment in a facility is received. Based on the HFA request, an HFA command is generated using a pre-defined template. The HFA command specifies attributes of the equipment in a format compatible with a workflow management system that is implemented to manage standard operating procedures (SOPs) of the facility. The HFA command is transmitted to an application executing on a communication device of the field operator.

### BACKGROUND

In facilities such as oil refineries, chemical plants, paper mills, etc., numerous processes are managed to ensure efficient and safe operations. These processes may involve the use of various types of equipment, such as pumps, valves, mixers, reactors, turbines, etc., depending on the type of facility and the specific processes involved.

Additionally, the processes may involve the use of various types of sensors and control systems to monitor and control various parameters, such as temperature, pressure, and flow rates of the equipments in the facility. Data from these sensors and control systems are often collected and analyzed in real-time to adjust and optimize the processes.

These processes typically include a combination of manual and automated tasks, each handled differently. For example, to perform tasks, such as changing a state of a valve, a mixer, or a pump installed in a facility, there may be actuators that may be operated through manual or automated means to open and close the valve or start and stop the pump and the mixer.

Such facilities may also have standard operating procedures (SOPs) in place to direct field operators in managing the processes of the facilities. These SOPs may include operator rounds, which direct field operators to manually check on a health of the equipments, conduct routine maintenance, perform data collection activities, such as a manual tank level dip, etc.

Automated tasks often involve the use of computerized systems like distributed control systems (DCSs) that allow operators to control and monitor various parameters of the processes of the facilities. For example, automated actuators and sensors can be controlled and monitored using DCSs.

Manual tasks, such as the ones included in the operator rounds, on the other hand, require the intervention of the field operators and are known as human field activities (HFAs). These tasks are indispensable for ensuring the smooth and efficient operation of the facilities.

### SUMMARY

The details of some embodiments of the subject matter described in this specification are set forth in the accompanying drawings and the description below. Other features, aspects, and advantages of the subject matter will become apparent from the description, the drawings, and the claims.

In one embodiment, there is provided a method for communicating human field activities (HFA) requests to field operators. The method comprises receiving an HFA request corresponding to an operation to be performed by a field operator. The operation may be related to an equipment in a facility.

The method further comprises generating an HFA command using a template based on the HFA request. The HFA command specifies attributes of the equipment in a format that is compatible with a workflow management system that is implemented to manage standard operating procedures (SOPs) of the facility. The HFA command is transmitted to an application executing on a communication device of the field operator through the workflow management system.

In another embodiment, a human field activity (HFA) service system comprises one or more processors and a human field activity (HFA) collector module coupled to the one or more processors. The HFA collector module is configured to identify, based on an HFA request, an operation to be performed by a field operator on an equipment in a facility. Based on the HFA request, the HFA collector module is configured to select a template from a library of predefined templates. The template comprises configurable parameters that are readable by a workflow management system. The workflow management system is implemented to manage the SOPs of the facility. The HFA collector module generates an HFA command by conforming the HFA request to the template by configuring attributes of the equipment associated with the HFA request into the configurable parameters of the template. A communication module of the HFA service system transmits the HFA command to a client of the workflow management system accessible by the field operator.

In yet another embodiment, a non-transitory computer-readable storage medium comprises instructions for execution by a processing resource is provided. The instructions, when executed by the processing resource, cause generation of an HFA command based on an HFA request and a template. The HFA request specifies an operation to be done on an equipment in a facility by a field operator. The template provides a format to specify attributes of the equipment in the HFA command. The format is compatible with a workflow management system that manages the SOPs of the facility. The attributes of the equipment that may be specified in the format include at least one of name of the equipment, type of the equipment, and instructions for the field operator. In an example, additional attributes of the equipment, such as geolocation of the equipment or asset identification, for example, NFC or barcode, of the equipment may be available in a database of the workflow management system. These additional attributes of the equipment may be included in the HFA command along with the information provided through the template format. Further, the instructions, when executed by the processing resource, cause the HFA command to be transmitted, via the workflow management system, to a communication device of the field operator and receive a response from the communication device indicating receipt of the HFA command at the communication device.

Providing the HFA requests to the field operators in accordance with embodiments of the subject matter described herein minimizes the intervention of control room operators. Thus, the present invention enables a reduction in the labor involved in carrying out human field activities in facilities and may also reduce errors due to miscommunication between the control room operators and the field operators.

Additional features and advantages are realized through the concepts of the present invention. Other embodiments and aspects of the invention are described in detail herein and are considered a part of the claimed invention.

### BRIEF DESCRIPTION OF FIGURES

Systems and/or methods, in accordance with examples of the present subject matter, are now described and with reference to the accompanying figures, in which:

FIG. 1 illustrates a network environment comprising a human field activity (HFA) service system to communicate a human field activity (HFA) request corresponding to an operation to be performed on an equipment in a facility to a field operator, in accordance with an example implementation of the present subject matter;

FIG. 2 depicts a hierarchical network architecture of a facility implementing an industrial process, in accordance with an example implementation of the present subject matter;

FIG. 3 illustrates an HFA service system to communicate an HFA request to a field operator in a facility, in accordance with an example implementation of the present subject matter;

FIG. 4 illustrates the HFA service system, in accordance with another example implementation of the present subject matter;

FIG. 5 illustrates a signal flow diagram depicting communication between various entities implemented in a facility, in accordance with an example implementation of the present subject matter;

FIG. 6 illustrates a method to communicate an HFA request to a field operator in a facility, in accordance with an example implementation of the present subject matter;

FIG. 7 illustrates the method to communicate an HFA request to a field operator, in accordance with another example implementation of the present subject matter;

FIG. 8 illustrates a method for indicating status of an HFA command, in accordance with an example implementation of the present subject matter; and

FIG. 9 illustrates a system environment implementing a non-transitory computer-readable medium comprising instructions for communicating an HFA request corresponding to an operation to be performed on an equipment in a facility to a field operator, in accordance with an example implementation of the present subject matter.

### DETAILED DESCRIPTION

Human Field Activities (HFAs) correspond to tasks that are not automated and thus are to be performed manually by field operators in a facility. Usually, HFA requests corresponding to the HFAs are raised manually and are visible only to control room operators, who are responsible for coordinating manual tasks underlying the HFA requests with the field operators who perform them.

A field operator responsible for handling an HFA request may not be fully aware of the details required to efficiently perform the manual tasks associated with the HFA request. In such cases, a control room operator may need to guide the field operator by providing additional instructions. For example, the control room operator may need to communicate with the field operator to gather more information or provide proper guidance to ensure that the task is performed correctly and safely. As a result, handling the HFA requests often involves extensive communication between the control room operator and the field operator.

In some cases, the control room operator may not have a comprehensive understanding of equipment's and/or processes of the facility, leading to incorrect guidance or directions. Similarly, the field operator may not have a clear understanding of the instructions or may misinterpret them, leading to delays in performing the manual task or incorrectly performing the manual task, in some cases.

Further, the control room operator may be required to manage multiple HFA requests at the same time, requiring the control room operator to comprehend and act upon large amounts of information. This may result in decreased performance. For example, the control room operator may make incorrect decisions or overlook critical information, leading to safety hazards and equipment damage.

Thus, involving the control room operator in the handling of the HFA requests may not only increase the workload of the control room, field operators, or both, but it also increases risks associated with human error.

There exist conventional solutions which provide for scheduling the HFA requests included in operator rounds or other predefined manual tasks, which are included in standard operating procedures (SOPs) of the facility, to be sent directly to the communication device of the field operator without requiring the intervention of the control room operator. Such existing solutions typically consolidate multiple HFA requests into tasks that can be scheduled for the field operators to execute during their rounds. A field operator downloads the schedule for his respective rounds onto the communication device and proceeds to execute instructions contained in the HFA requests one after another as indicated by the schedule. The operator also records the status of each completed HFA on the communication device. At the end of the round, a cumulative status of all completed HFAs is uploaded back to a source that submitted the original HFA request. Since the operator updates the status of completion of all tasks in one go, instances of delay are common.

Accordingly, in such conventional approaches, the requesting application needs to wait until the field operator completes all the HFAs in their schedule to upload the status to the source. Thus, the conventional approaches do not cater to situations where one or more of the multiple tasks scheduled for a field operator is a task that needs to be attended to on priority without involving much wait time such that a status of completion of the urgent task may be updated promptly and independent of the status of the other scheduled tasks.

Additionally, the current solutions lack the ability to establish application-specific definitions for the HFAs requests originating from various sources that may not be readily understood by the existing solutions. The application-specific definitions of the HFA request may refer to interpretations of the HFA requests that are understandable by a particular application or system. As a result, the existing solutions may be incapable of effectively incorporating the scheduling of the operator rounds or other manual tasks as defined in the facility's SOP.

Furthermore, it is also not possible to establish two-way communication between all sources capable of submitting the HFA requests and the field operator using the existing solutions. This lack of direct interaction between the field operator and the sources submitting the HFA requests may be attributed to various reasons. In some cases, source submitting the HFA request and devices used by the field operator to receive instructions pertaining to the manual tasks may use different communication protocols, making it difficult to establish a direct communication link between the source and the field operator's devices.

Thus, implementing a secure, two-way communication for communicating the HFA requests between a source and the communication device of the field operator, especially when communication is to take place across multiple untrusted networks is not feasible using the conventional solutions.

According to example implementations of the present subject matter, techniques to communicate HFA requests from a source to a field operator's device are described. The source refers to any application that may be implemented within an industrial facility and is capable of generating the HFA requests. The source may vary depending on the specific requirements and operations of the facility. The source may be a custom-built software application, a third-party application, or even a combination of multiple applications integrated together to manage various aspects of the facility's operations.

The example techniques to communicate the HFA requests enable the elimination of intervention of control room operators in carrying out the HFA requests and provide for communicating the HFA requests to the field operators' device in a secure manner.

In example implementations, a method to communicate HFA requests includes receiving an HFA request corresponding to an operation to be performed by a field operator on an equipment in the facility. Based on the HFA request that is received, an HFA command is generated using a template. The HFA command specifies at least one actionable task item pertaining to the operation to be performed by the field operator on the equipment and attributes of the equipment in a format that is compatible with a workflow management system (WMS) that is used to define and monitor SOPs of the facility. In an example embodiment, the WMS acts as an interface that receives the HFA command and transmits the HFA command to a communication device of the field operator.

In an example, to define, monitor, and control material movements inside the facility a movement management application (MMA) is generally used. The MMA may be understood as a system that runs in conjunction with a distributed control system (DCS) of the facility to help automate movement of resources in the facility. In an example embodiment, the DCS may be a network of independent PLCs interconnected by means of a wired or wireless transmission media to control operation of equipments installed in the facility based on the instructions received from the MMA. The MMA directly interacts with the DCS to command or control equipments that MMA needs for executing the material movements in the facility. However, there may be certain operations or equipments that the MMA cannot manage through the DCS and require manual intervention from the field operators. In such cases, the MMA may initiate an HFA request corresponding to an operation or equipment that cannot be executed or controlled through the DCS and may require manual intervention from the field operators.

Translating the HFA request into the HFA command in accordance with the template allows the WMS to understand the received HFA request, such that the actionable task item and attributes relating to the equipment associated with the HFA request are readable by the WMS.

In an example, the actionable task item pertaining to an operation to be performed on the equipment dictates a manual action involved in the operation. The attributes of the equipment are properties of the equipment. Examples of the attributes that are received with the HFA request include, but are not limited to, type of the equipment, name of the equipment, and instructions for the field operator. Accordingly, an HFA command is generated based on an HFA request to perform a manual operation on the equipment. For example, an HFA command corresponding to an HFA request for a manual pump may specify the actionable task item as ‘turn ON’ the manual pump. Also, the HFA command may specify the attributes of the equipment, for example, an identification, such as an ID number of the manual pump, and instructions, such as steps to be followed to ‘turn ON’ the manual pump. The HFA command specifies the actionable task item and attributes in a format prescribed by the template that is compatible with the WMS.

As explained previously, the HFA command is transmitted to an application executing on the communication device of the field operator through the WMS. In accordance with an implementation of the present subject matter, the application executing on the communication device of the field operator receives the HFA command comprising the actionable task item pertaining to the operation to be performed by the field operator on the equipment and other attributes of the equipment. In an example implementation, the actionable task item is presented on the communication device as HMI screens to guide the field operator on the operation to be performed on the equipment. Referring to the previous example of the operation of turning ON the manual pump, the HMI screens may comprise a photo or a pictorial representation of the manual pump depicting a switch of the manual pump that is operable for turning ON the manual pump. Once the HFA request is executed by the field operator, an HFA status is generated by the field operator using the communication device. The HFA status is indicative of the completion of the HFA request included in the HFA command. This HFA status is communicated back to the movement management system that submitted the HFA request.

In accordance with example implementations of the present subject matter, since the HFA requests are sent directly to the field operator, there is a reduced need for the control room operator in the process of communicating the HFA requests. This may result in a quicker, more accurate transfer of the HFA requests to the field operators and in receiving an indication of completion of the HFAs from the field operator, thereby facilitating a reduction in the overall execution time of the HFA requests.

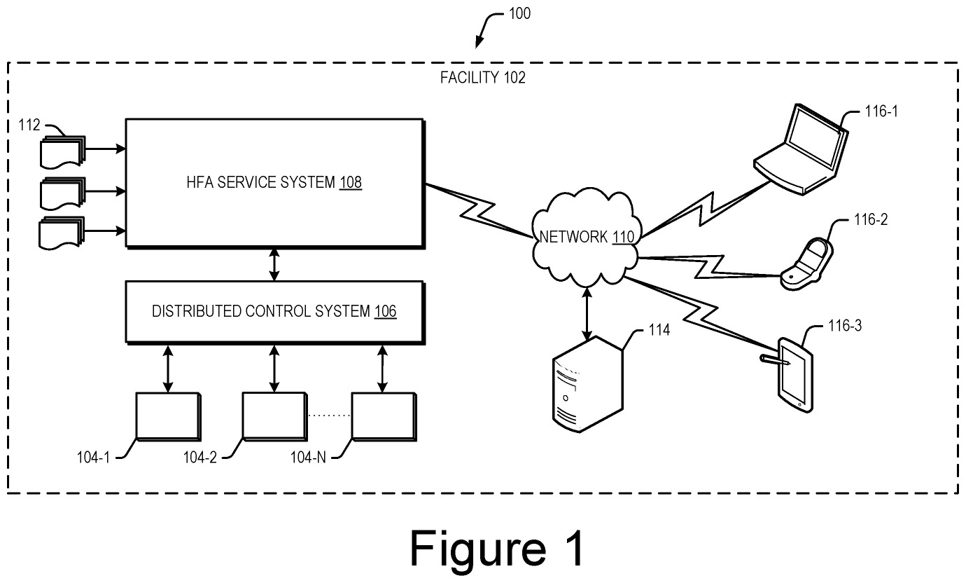

The above techniques are further described with reference to FIG. 1 to FIG. 9. It should be noted that the description and the Figures merely illustrate the principles of the present subject matter along with examples described herein and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates a network environment 100 for implementing examples techniques to communicate HFA requests to field operators, in accordance with an example implementation of the present subject matter.

Industrial processes are carried out in a facility 102, such as oil refineries, chemical plants, paper mills, etc. In the facility 102, multiple equipments 104-1, 104-2 . . . , 104-n operate in conjunction with each other to accomplish a predefined objective. Such equipments 104-1, 104-2 . . . , 104-n are generally interfaced with a DCS 106 installed in the facility 102. The DCS 106 may be understood as a computerized control system that may be used to monitor and control operations of equipments 104-1, 104-2 . . . , 104-n. The DCS 106 may be composed of hardware and software components, such as sensors, controllers, and human-machine interfaces (HMIs), that work together to manage and optimize processes of the facility 102. The DCS 106 may be monitored by a control room operator to control operation of the different equipments 104-1, 104-2 . . . , 104-n, which may include, for example, pumps, valves, and reactors, involved in the processes of the facility 102 from a central control room.

The DCS 106 may use real-time data and feedback from the equipments 104-1, 104-2 . . . , 104-n to monitor and control their operation. The control room operator may set variable parameters for the equipments 104-1, 104-2 . . . , 104-n, such as flow rate, temperature, and pressure, and the DCS 106 may adjust the equipments 104-1, 104-2 . . . , 104-n to maintain those parameters.

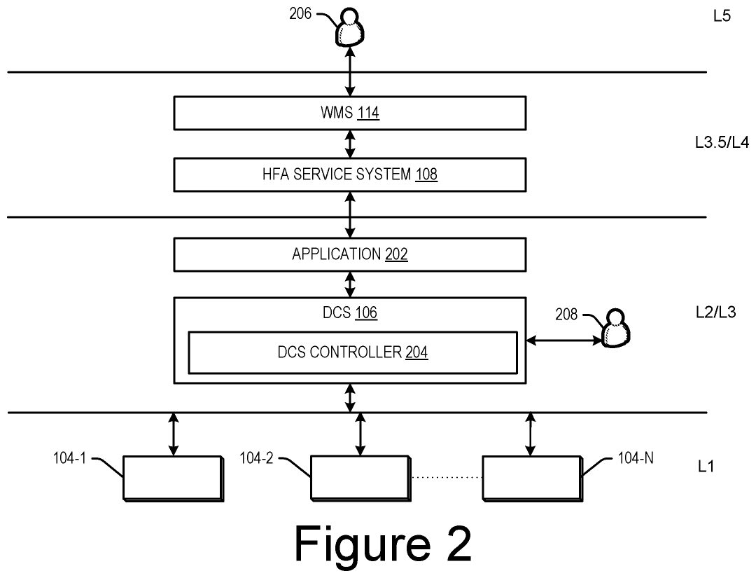

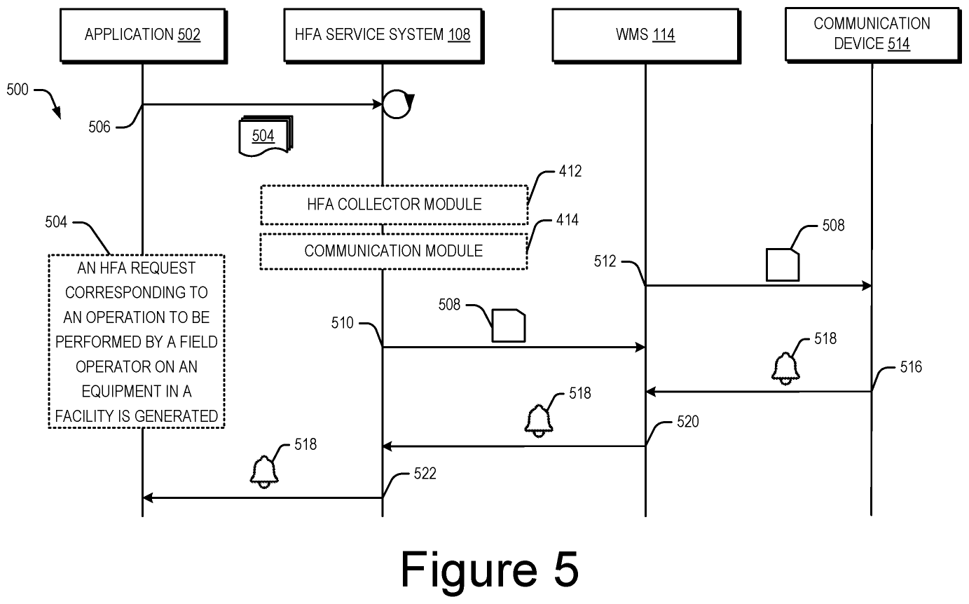

Further, as explained previously, an MMA (illustrated in FIGS. 2 and 5) may be implemented in the facility 102 to define, monitor, and control material movements inside the facility 102, in an example. The MMA may be any computing device, such as a server, a desktop computer, a laptop, a smartphone, or a tablet. The MMA may work in conjunction with the DCS 106 to control the equipments 104-1, 104-2 . . . , 104-n, and other components of the facility 102 to facilitate the material movements inside the facility 102. For standard tasks that need to be regularly performed using the one or more equipments 104-1, 104-2 . . . , 104-n, the MMA may directly or remotely interact with the DCS 106 to command or control the one or more equipments 104-1, 104-2 . . . , 104-n that the MMA needs for performing the standard tasks. However, there may also be instances where manual intervention by the field operators may be needed in the facility 102. For example, such instances may arise out of sequence, for which there may be no established SOP and hence cannot be controlled through the DCS 106. The tasks that are out of sequence, not defined as per the SOP and/or not enabled through the MMA or any other similar application in the control network of the facility 102, may be understood as out-of-turn tasks, and are usually those that are not part of regular material movements or routine operation or maintenance procedures for the equipments 104-1, 104-2 . . . , 104-n. Such tasks may arise unexpectedly or as a result of changes in the processes of the facility 102. Similarly, it will also be understood that there may be tasks that may be a part of a regular operation involving material movements, operations, or equipments 104-1, 104-2 . . . , 104-n maintenance, that may require the field operators to step in and handle these tasks manually. For instance, a routine maintenance task, such as regulating a cooling medium flow into a reactor of a facility, such as the facility 102, to keep temperature of the reactor within a desired range may necessitate manual intervention from the field operator as the same may not be regulated through the DCS 106. In this case, the field operator may physically adjust a manual valve to regulate the cooling medium flow into the reactor, bringing the temperature back within the desired range.

These tasks may require additional knowledge or expertise beyond what is provided for in the SOP or may involve circumstances that may not be automated through the DCS 106. Examples of such tasks may include but are not limited to, troubleshooting equipment issues, addressing unexpected downtime, or responding to emergencies. Such tasks may involve one or more human field activities (HFA) to be performed.

To manage the HFAs that may not be managed by the MMA through the DCS 106 and require manual intervention from the field operators, a human field activity (HFA) service system 108 may be implemented to automate the process of communicating HFA requests for performing the HFAs associated with such tasks to the field operators, in accordance with an example of the present subject matter. Communicating the HFA requests directly to the field operators without the intervention of control room operators in the process of handling the HFAs, provides for streamlining the workflow and improving the efficiency of the facility 102.

In one embodiment, the HFA service system 108 may be a computing device. In some embodiments, the HFA service system 108 may communicate with the DCS 106 and the MMA either directly or over a network 110. In some other embodiments, the HFA service system 102 may also be part of a hosted service executed on a workflow management system (WMS) (illustrated in FIG. 2).

In an example, the network 110 may be a single network or a combination of multiple networks and may use a variety of different communication protocols. The network may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 110 includes various network entities, such as gateways, routers; however, such details have been omitted for the sake of brevity of the present description.

According to an embodiment of the present invention, the HFA service system 108 receives an HFA request 112. The HFA request 112 corresponds to a manual task or operation, i.e., HFA, that is to be performed by a field operator on the one or more of equipment's 104-1, 104-2 . . . , 104-n installed in the facility 102. In an example, the HFA request 112 may arise out of an out-of-turn task or may be related to the regular material movements or routine operation or maintenance procedures for the equipments 104-1, 104-2 . . . , 104-n. For example, in an industrial facility like an oil refinery, during a normal operation of the refinery, a sudden equipment malfunction may occur that is not covered by the SOPs or any predefined tasks within the MMA. This malfunction may require immediate attention and manual intervention from the field operator to troubleshoot and resolve the malfunction. Since troubleshooting this specific malfunction is an out-of-turn task and not part of the regular MMA-controlled operations, the MMA itself may not be able to directly send an HFA request corresponding to an HFA to be performed to troubleshoot the malfunction to the field operator. The DCS 106, being designed for standard operations and tasks, may not be equipped to handle such out-of-turn requests either. To address this situation, the HFA service system 108 may be used. When the malfunction arises, the HFA service system 108 receives the HFA request, generated either by the MMA or another application. The HFA service system 108 then acts as an intermediary between the MMA and the communication devices 116-1, 116-2, 116-3 used by the field operators.

However, an issue may arise if format of the HFA request 112 generated by the MMA is not compatible with the communication device 116-1, 116-2, 116-3 used by the field operator. As a result, the communication device 116-1, 116-2, 116-3 may not comprehend and process the HFA request 112, rendering the operator unable to execute the HFA request. Moreover, there may be a plurality of MMAs, or other similar applications implemented in the facility 102 that may generate the HFA requests, such as the HFA request 112. Such MMAs may not be in directly linked with the communication device 116-1, 116-2, 116-3 of the field operator who is to be tasked with the execution of the HFA requests. To address this issue and eliminate the need to involve the control room operator in transmitting the HFA request 112 to the field operator, the WMS 114 may be involved to process the HFA request 112 and deliver the same to the communication device 116-1, 116-2, 116-3 of the field operator.

In an example, the WMS 114 may act as an interface between the HFA service system 108 and communication device 116-1, 116-2, 116-3 of the field operator. For successful transmission of the HFA request 112, the HFA request 112 needs to be in a format that the WMS 114 may comprehend, enabling it to convey the HFA request 112 generated by the MMA in a format compatible with the communication device 116-1, 116-2, 116-3.

To this end, the HFA service system 108 provides templates that enable the translation of the HFA request 112 in a format that is compatible with the WMS 114. A template comprises configurable parameters that may be configured to specify at least one actionable task item pertaining to the operation to be performed on an equipment and attributes of said equipment in a format that is compatible with the WMS 114. Based on the HFA request 112 received at the HFA service system 108, the HFA service system 108 generates an HFA command using the template corresponding to the operation to be performed on the equipment.

Thereafter, the WMS 114, over the network 110, transmits the HFA command to an application executing on the communication device 116-1, 116-2, 116-3 of the field operator. Examples of the communication device 116-1, 116-2, 116-3 may include but are not limited to, electronic devices, such as a desktop computer, a laptop, a smartphone, a personal digital assistant (PDA), a tablet, and other industrial secured and hardened handheld devices such as Honeywell Dolphin CT60©. In an example, the application executing on the communication device 116-1, 116-2, 116-3 of the field operator may be a client application corresponding to a server application execution in the WMS 114.

In an example, once the task specified in the HFA command is complete, the field operator provides an indication of completion of the HFA command through a status update on the communication device 116-1, 116-2, 116-3. This status update is received by the WMS 114. The WMS 114 thereafter relays the status back to the application that submitted the HFA request 112, through the HFA service system 108. A closed loop is considered complete when the application generating the HFA request 112 receives a status of completion of the operation.

FIG. 2 depicts a hierarchical network architecture of the facility 102 implementing the HFA service system 108 in accordance with an example implementation of the present subject matter.

As shown in FIG. 2, generally, there are five network layers in any industrial facility, such as the facility 102, namely L1, L2, L3, L4, and L5. In general, field equipment's, such as the equipment's 104-1, 104-2 . . . , 104-n are considered to be in the layer L1 of the facility 102. Further, applications, such as the DCS 106, application 202, which are similar to the MMA as described in reference to FIG. 1, are at the network layer L2 and L3, which is considered to be a process control network. The applications, such as the DCS 106, at the process control network, are configured to manage and control the one or more of equipment's 104-1, 104-2 . . . , 104-n installed in the facility 102, for example, through one or more DCS controllers 204 based on the instructions received from the application 202.

Furthermore, the HFA service system 108 and the WMS 114 are implemented at the network layers L3.5 or L4, which is considered to be a process information network. The network layer L5 is an internet layer that facilitates a connection of different applications and equipment's of the facility, such as the communication device 116-1, 116-2, 116-3 of the field operator, through a Wi-Fi network of the facility 102, allowing flow of data between the different applications and the equipment's implemented in the facility 102. It is possible that the HFA requests, such as the HFA requests 112 are generated at the lower network layers, for example, by the applications located at the network layer L2 or L3 in an example.

The HFA service system 108 makes such HFA requests 112 available to a field operator 206 who is responsible for carrying out the tasks required in the facility 102, in contrast to being visible only to a control room operator 208 who is responsible for monitoring the processes in the facility 102 and making decisions based on the information provided by the DCS 106 and other systems of the facility 102.

In accordance with an example embodiment of the present subject matter, applications installed at any network level in the facility 102 may be able to submit an HFA request, such as the HFA request 112, to the HFA service system 108. The HFA service system 108 generates the HFA command corresponding to the HFA request 112 using the template. Thereafter, the HFA command is transmitted to the application executing on the communication device 116-1, 116-2, 116-3 of the field operator 206 for completion.

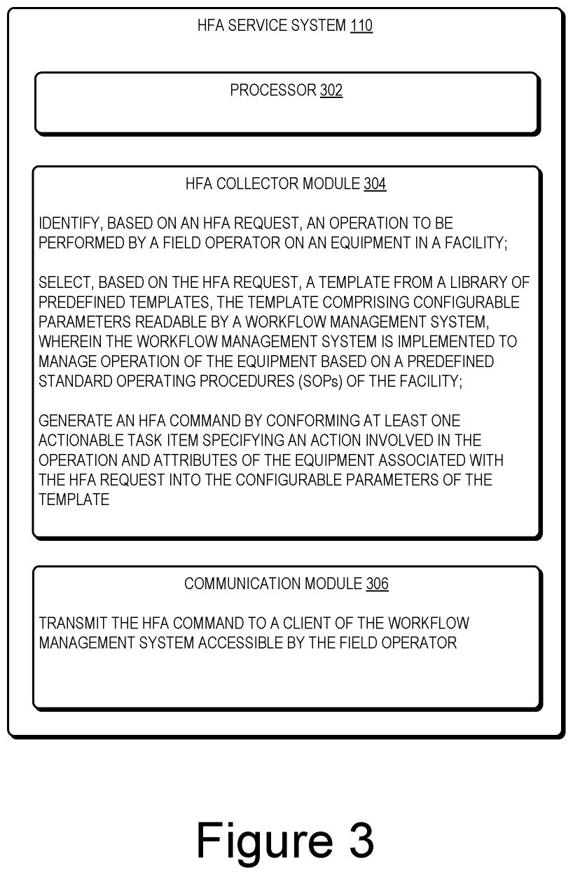

FIG. 3 shows the HFA service system 108, according to an example implementation of the present subject matter. As discussed previously, the HFA service system 108 may be one or more computing devices, such as desktop computers, laptops, smartphones, personal digital assistants (PDAs), tablets, and servers.

In an example, the HFA service system 108 comprises a human field activity (HFA) collector module 304, and a communication module 306, each coupled to a processor 302 of the HFA service system 108. In an example, the processor 302 may be implemented as microprocessors, microcomputers, microcontrollers, digital signal processors, central processing units, state machines, logic circuitries, and/or any devices that manipulate signals based on operational instructions. The processor 302 may execute instructions stored in the HFA collector module 304 and the communication module 306 to accomplish functionalities of the HFA service system 108.

The HFA collector module 304 is operable to receive an HFA command corresponding to an operation or an HFA be performed on one of the one or more of equipments 104-1, 104-2 . . . , 104-n of the facility 102. For example, the HFA command may correspond to a manual task that may not be automated by the DCS 106. In an example embodiment, the HFA request 112 to perform the manual task may be received from a device of a peer, for example, a second field operator in the facility 102. In another embodiment, the HFA request 112 may be received from a background process or service of the MMA implemented in the facility 102. The background process may generate the HFA request 112 and submit the same to the HFA service system 108 for processing. As explained previously, the MMA may be a software system configured to manage the movement of materials, products, and equipment's throughout the facility 102. The MMA may be interfaced with the DCS 106 and the WMS 114 to provide real-time visibility and control over the movement of goods and equipment's in the facility 102. In an alternative embodiment, any application implemented in the facility 102 may generate the HFA request 112 in a format complying with the template and submit the same to HFA service system 108 for processing.

In an example, the HFA request 112 may be submitted in a form of XML files or relational database scripts to the HFA collector module 304. The HFA collector module 304 identifies an operation to be performed on an equipment based on an HFA request 112. Upon identifying the operation and the equipment, the HFA collector module 304 selects a template from a library of predefined templates. As mentioned above, the template comprises configurable parameters readable by the WMS 114. The HFA collector module 304 uses the identified template to transform the HFA request 112 to a data structure that may be understood by the WMS 114. The HFA collector module 304 generates an HFA command by conforming the HFA request 112 to the template by configuring, into the configurable parameters of the template, at least one actionable task item pertaining to the operation to be performed by the field operator on the equipment and attributes associated with the equipment.

Thereafter, the communication module 414, via the WMS 114, transmits the HFA command to the application executing on the communication device 116-1, 116-2, 116-3 of the field operator 206.

In an example, the application running on the communication device 116-1, 116-2, 116-3 receives the HFA command. In accordance with an implementation of the present subject matter, the actionable task item and attributes of the equipment are presented on the communication device 116-1, 116-2, 116-3 as a series of HMI screens to guide the field operator 206 on the operation to be performed on the equipment. For example, in a power plant, a field operator, such as the field operator 206, equipped with the communication device, such as a smartphone, receives an HFA command to perform a maintenance task on a specific generator. Upon receiving the HFA command, the application on the smartphone displays a series of HMI screens that provide detailed instructions, safety guidelines, and relevant equipment attributes related to the maintenance task. The HMI screens guide the field operator through each step of the procedure, ensuring that the task is performed correctly and safely. As the field operator follows the instructions on the HMI screens, the record field operator may record the status and outcomes of each step directly on the application. Once the maintenance task is completed, the field operator may upload the status of the completed HFA back to the smartphone which may be transmitted back to the MMA through the WMS 114 and the HFA service system 108. This process enhances efficiency, reduces errors, and streamlines communication between the field operator and the MMA.

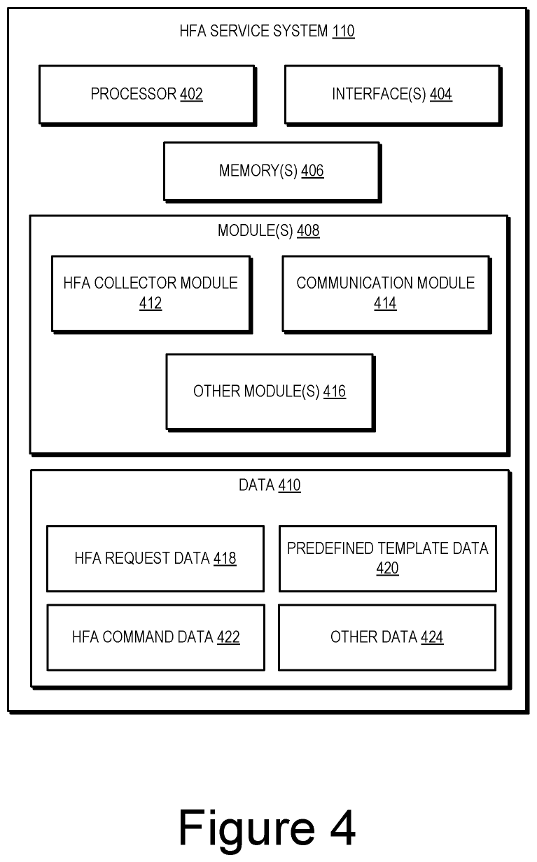

FIG. 4 illustrates the HFA service system 108, in accordance with another example implementation of the present subject matter,

As illustrated in FIG. 4, the HFA service system 108 may include a processor 402, interface(s) 404, and memory(s) 406. The processor 402, similar to the processor 302 explained in reference to FIG. 3, may be implemented as microprocessors, microcomputers, microcontrollers, digital signal processors, central processing units, state machines, logic circuitries, and/or other devices that manipulate signals based on operational instructions. The interface(s) 404 may allow the connection or coupling of the HFA service system 108 with one or more other devices, such as the DCS 106 or the WMS 114, through a wired (e.g., Local Area Network, i.e., LAN) connection or a wireless connection (e.g., Bluetooth®, Wi-Fi). The interface(s) 404 may also enable intercommunication between different logical as well as hardware components of the HFA service system 108.

The memory(s) 406 may be a computer-readable medium, examples of which include volatile memory (e.g., RAM), and/or non-volatile memory (e.g., Erasable Programmable read-only memory, i.e., EPROM, flash memory, etc.). The memory(s) 406 may be an external memory, or internal memory, such as a flash drive, a compact disk drive, an external hard disk drive, or the like. The memory(s) 406 may further include data 410 that either may be utilized or generated during the operation of the HFA service system 108.

The HFA service system 108 may further include module(s) 408. The module(s) 408 may be implemented as a combination of hardware and programming, for example, programmable instructions to implement a variety of functionalities of the module(s) 408. In examples described herein, such combinations of hardware and programming may be implemented in several different ways. For example, the programming for the module(s) 408 may be executable instructions. Such instructions may be stored on a non-transitory machine-readable storage medium which may be coupled either directly with the HFA service system 108 or indirectly (for example, through networked means). In an example, the module(s) 408 may include a processing resource, for example, either a single processor or a combination of multiple processors, to execute such instructions. In the present examples, the non-transitory machine-readable storage medium may store instructions that, when executed by the processing resource, implement module(s) 408. In other examples, the module(s) 408 may be implemented as electronic circuitry.

The module(s) 408 includes an HFA collector module 412, a communication module 414, and other module(s) 416. The HFA collector module 412 and the communication module 414 are similar to the HFA collector module 304 and the communication module 306, respectively, discussed in reference to FIG. 3. The other module(s) 412 may further implement functionalities that supplement functions performed by the HFA service system 108 or any of the module(s) 408. The data 410, on the other hand, includes data that is either stored or generated as a result of functions implemented by any of the module(s) 408 or the HFA service system 108. It may be further noted that information stored and available in data 410 may be utilized by the module(s) 408 for performing various functions by the HFA service system 108. In an example, data 410 may include HFA request data 418, template data 420, HFA command data 422, and other data 424.

In operation, the HFA collector module 412 of the HFA service system 108 may receive an HFA request 112, for example, an HFA request corresponding to an operation to be performed on the equipment 104-1 installed in the facility 102. For instance, the operation may involve one or more tasks that may need to be performed in the oil refinery, such as, opening or closing of a valve to a certain degree to achieve a predefined flow rate of oil. An intervention by a field operator, such as the field operator 206, may be required to manually actuate the valve to control the flow rate of oil. This may involve physically turning a valve handle.

The HFA request 112 to perform the operation may be submitted to the HFA collector module 412 by the MMA 202. Data corresponding to the HFA request 112 may be stored in the data 410 as the HFA request data 418.

The HFA collector module 412 may provide a number of approaches for the MMA 202 to submit the HFA request 112. For example, the HFA request 112 may be received in different formats that may include, but are not limited to, spreadsheets, scripts written in SQL or other relational database languages, or even as program files.

The HFA request 112 may contain at least one actionable task item indicative of the operation and attributes related to the equipment on which the operation is to be performed. For example, in the case of the valve in the oil refinery as discussed previously, the actionable task item may include the opening or closing of the valve, and the attributes may include identification of the valve, degree by which the valve needs to be rotated control to achieve the predefined flow rate of oil, a priority level of the task, a start and end time of the task, or any other specific instruction related to the task. In an example embodiment, instructions that are not actionable task items may also be part of the HFA request 112. Such non-actionable task items may be specified as part of the HFA request 112. In an example, a control room operator 208 who is able to view and monitor processing of the HFA request 112 may also be able to edit and add to the instructions, if needed.

To enable the WMS 114 to read the HFA request 112, the HFA collector module 412 may process the HFA request to translate information, such as the actionable task items and the attributes, contained in the HFA request 112 in a format that may be understood by the WMS 114. For doing so, the HFA collector module 412 uses a predefined template stored in the predefined template data 420.

As discussed previously, a predefined template, available in the HFA service system 108, provides a fixed structure or format to provide the information required to process the HFA requests 112 to the WMS 114. The predefined template may contain a set of configurable parameters or fields that may be filled by extracting the at least one actionable task item and the attributes from the HFA request 112.

In an example embodiment, templates may be created beforehand for different types of equipment and various operations that may be performed on the equipments and stored in the predefined template data 420.

For example, in the case of the valve in the oil refinery discussed previously, a template that corresponds to the HFA request related to the opening/closing of the valve may be identified from amongst the various predefined templates stored in the predefined template data 420.

Once the template is identified by the HFA collector module 412, the actionable task items and the attributes, such as the opening or closing of the valve, the identification of the valve, and the degree by which the valve needs to be rotated may be extracted from the HFA request and the respective configurable fields of the template may be configured accordingly to generate the HFA command. In an example, additional attributes of the equipment, that may not be specified in the HFA request 112 may also be configured in the HFA command.

In an example embodiment, the additional attributes may be requested or extracted from the WMS 114. For example, in the case of the valve in the oil refinery, the additional attributes relating to the valve that may be extracted from the WMS 114, include the geolocation of the valve, any safety considerations or precautions that needs to be taken while handling the valve, etc. In an alternative embodiment, it is possible that all the attributes pertaining to the HFA request 112 may be included within the HFA request 112 itself by the movement management application requiring the execution of the task.

In an embodiment, the templates may be dynamically modified to include additional attributes that may be necessary for better handling the HFA requests 112 by the WMS 114. For example, in the case of the valve in the oil refinery, it is possible that the task to close the valve involved five steps, and a first field operator assigned to execute said task only completed up to second step and left the facility 102 due to an emergency. In such a case, a second field operator may have to be assigned to complete the execution of the task. In doing so, the template that is associated with the task may be modified to specify that the task is executed till the second step and the second field operator needs to execute the remaining steps to complete the closure of the valve.

For instance, in the example of the oil refinery as discussed previously, to regulate the flow in the pipeline, along with the valve, a pressure regulator may also be used which may be adjusted to regulate the flow in the pipeline. An HFA request received for executing an operation of adjusting the pressure regulator may also include different actionable task items and attributes than those of the valve. For instance, for the HFA request corresponding to the pressure regulator, an actionable task item may include adjusting pressure setting of the pressure regulator and the attributes may include allowable flow rate, allowable pressure range, etc. Hence, the HFA request corresponding to the pressure regulator may have to be assigned a template that comprises fields that may be configured to fill the template with the actionable task items and the attributes which are relevant to the execution of the HFA request that specifically corresponds to the pressure regulator.

Once the HFA request 112 is translated in accordance with the template by configuring the actionable task items and attributes of the equipment associated with the HFA request 112 into the configurable parameters provided by the template, the HFA collector module 412 generates an HFA command corresponding to the HFA request 112 and stores the same in the HFA command data 422 in a prescribed format. The HFA command generated by the HFA collector module 412 may be as per template understood by the WMS 114. In yet another example, the template of the HFA command may be such that it is processable by the WMS 114 on the network 110. With the HFA command generated, the HFA collector module 412 may transmit a file comprising the HFA command to the WMS 114 through the network 110.

As explained previously, the HFA command may comprise at least one actionable task item pertaining to the operation to be performed by the field operator 206 on the equipment and attributes of the equipment for which the HFA request 112 is received by the HFA service system 108. The attributes may, for example, include links to access the geolocation of the equipment in the facility 102, and images of the equipment. The actionable task item may include details of specific tasks that may need to be performed to complete the operation specified in the HFA command. For example, an HFA request for equipment maintenance may require the field operator 206 to open the equipment, perform a visual inspection, and replace a damaged part. The HFA command corresponding to this HFA request may include a link to the geolocation of the equipment, images of the equipment, and specific instructions on how to carry out the task of opening the equipment and replacing the damaged part.

In an example, the communication module 414 transmits the HFA command to the WMS 114. Thereafter, the WMS 114 further transmits the HFA command to the application executing on the communication device 116-1, 116-2, 116-3 of the field operator 206. In an example, the HFA command when received on the communication device 116-1, 116-2, 116-3, may present the actionable task items and attributes that may be embedded with the HFA command using a series of HMI screens displayable on the communication device 116-1, 116-2, 116-3 to guide the field operator 206 on the operation to be performed corresponding to the received HFA request 112. For example, in the above example of the valve in the oil refinery, the actionable task item and attributes associated HFA request pertaining to the valve may be shown as an HMI screen, for instance, showing a direction in which the valve needs to be rotated for the closing the valve, geolocation of the valve in the oil refinery may be shown as a graphical map, etc.

As explained previously, in an example, using the communication device 116-1, 116-2, 116-3, the field operator 206 may provide a notification regarding completion of execution of the HFA command to the WMS 114. The WMS 114 may then send a notification confirming the completion of the execution of the HFA command to the HFA service system 108. The HFA service system 108 may further transmit a notification regarding the completion of the manual task included in the HFA request 112 to the MMA 202 from where the HFA request 112 was originally received, thus enabling a closed-loop operation. Once the MMA 202 receives the completion confirmation of the out-of-turn task, the process moves further.

In an example embodiment, if the communication device 116-1, 116-2, 116-3 used by the field operator 206 is determined by the WMS 114 to be outside the network's 110 coverage area in the facility 102, any HFA command intended for that communication device 116-1, 116-2, 116-3 may be placed in a queue until the communication device 116-1, 116-2, 116-3 is detected within the network's 110 coverage area. Once the communication device 116-1, 116-2, 116-3 used by the field operator 206 is detected to be within the coverage area of the network 110, the HFA command may be delivered to that communication device 116-1, 116-2, 116-3. In another example embodiment, the control room operator 208 in the control room may have an option to monitor the network status of the communication device 116-1, 116-2, 116-3 used by the field operator 206 and, if necessary, may choose to reassign the HFA command to another available field operator based on the network status of the of the communication device 116-1, 116-2, 116-3 of the filed operators.

In another example embodiment, a web-based user interface may be provided to the control room operator 208 in the control room, allowing the control room operator 208 to monitor the HFA commands and the status of the communication device 116-1, 116-2, 116-3 used by the field operator 206 with respect to its coverage area within the network 110, and consequently set the field operator's 206 status as either shift/available or out of shift/not available. If the field operator 206 completes the HFA command that is delivered on the communication device 116-1, 116-2, 116-3 of the field operator 206 and the communication device 116-1, 116-2, 116-3 were to then move out of the network coverage area, the status of the HFA command is captured and cached on the communication device 116-1, 116-2, 116-3 until the time the communication device 116-1, 116-2, 116-3 is detected into the network 110 coverage area. Once the communication device 116-1, 116-2, 116-3 is in the coverage area of the network 110, the cached status of the HFA command is communicated back to the WMS 114 to relay the status back to the application that submitted the HFA request 112 thus completing the closed loop. Non-actionable instructions that accompany actions for the field operator 206 may be communicated as part of the HFA request 112 or the control room operator 208 may add them from the web-based user interface provided for the control room operator 208.

FIG. 5 illustrates a signal flow diagram 500 depicting communication between various entities implemented in a facility, such as the facility 102 explained in reference to FIGS. 1-4, in accordance with an example implementation of the present subject matter.

The present explanation is provided with reference to the HFA service system 108. In an example, to control the equipments 104-1, 104-2 . . . , 104-n of the facility 102, the MMA, such as the MMA 202, may define values for operating parameters of one or more of the equipments 104-1, 104-2 . . . , 104-n. Examples of the operating parameters may include operational state, such as an ‘off’ or ‘on’ state of an equipment as well as the variable parameters, such as temperature and pressure associated with various components of the equipment, that may be sensed, for example, by a corresponding sensor.

As discussed previously, the facility 102 may include the HFA service system 108, and a workflow management system, such as the WMS 114. The HFA service system 108 may be in communication with the WMS 114. The WMS 114 in turn may be in communication with a communication device 514 which may be similar to the communication device 116-1, 116-2, 116-3 discussed in reference to FIGS. 1-4.

In an example implementation of the present subject matter, an HFA request 504, similar to the previously described HFA request 112, may be received at the HFA service system 108 from an application 502, for example the MMA 202 discussed previously, that may be implemented at the network layer L2 or L3 in the facility 102. The HFA request 504 corresponds to a manual task that may not be managed by the MMA 202 through the DCS 106. As explained previously, in an example, the HFA request 504 may relate to the manual task that may arise out-of-turn or may be part of the regular material movements or routine operation or maintenance procedures for the equipments 104-1, 104-2 . . . , 104-n. In an example, the HFA request 504 may include data corresponding to at least one actionable task item and attributes related to the equipment on which the operation is to be performed. As indicated by step 506, the HFA request 504 is first received at the HFA service system 108 from the application 502. Thereafter, the HFA request 504 is transferred to the HFA collector module 412 of HFA service system 108.

The application 502 may communicate the HFA request 504 to the HFA service system 108 via one or more communication channels, such as the network 110. Each of such channels may implement communication using different communication protocols. Examples of such communication protocols include, but are not limited to, OPC alarm & event (OPC AE), OPC unified architecture (OPC UA), open database connectivity (ODBC), transmission control protocol/internet protocol (TCP/IP), serial communication protocol, and file transfer protocol.

In an example, based on the HFA request 504, the HFA collector module 412 identifies the equipment and the operation to be performed on the equipment. Upon identifying the operation and the equipment, the HFA collector module 412 identifies a template that corresponds to the HFA request 504. As discussed previously, the template comprises configurable parameters readable by the WMS 114. The HFA collector module 412 uses the identified template to transform the HFA request 504 to a data structure that may be understood by the WMS 114. The HFA collector module 412 then generates an HFA command 508 by conforming the HFA request 504 to the template. In an example, the HFA request 504 may be conformed into the configurable parameters of the template by configuring at least one actionable task item pertaining to the operation to be performed by the field operator on the equipment and attributes of the associated equipment into the configurable parameters of the template.

A communication module, such as the communication module 414, may then communicate the HFA command 508 to the WMS 114 (as indicated in step 510). As indicated in step 512, once the HFA command 508 is received at the WMS 114, the WMS 114 communicates the HFA command 508, for example, through the Wi-Fi network implemented in the facility 102, to the communication device 514 of the field operator 206. In an alternative embodiment, instead of the Wi-Fi network, any other communication network, such as a cellular network, or LTE, that is secured by implementing an enterprise Virtual Private Network may also be used.

In an example, an application running on the communication device 514 receives the HFA command 508 comprising the at least one actionable task item pertaining to the operation to be performed by the field operator 206 on the equipment and attributes of the equipment. In accordance with an implementation of the present subject matter, the actionable task item is presented on the communication device 514 as a series of HMI screens to guide the field operator 206 on the operation.

As indicated in step 516, once the HFA command 508 is executed, the field operator 206, using the communication device 504, may provide a notification 518 regarding completion of the HFA command 508 to the WMS 114 via the Wi-Fi network of the facility 102. As indicated in step 520, the WMS 114 may accordingly further transmit the notification 518 confirming the execution of the HFA command 508 to the HFA service system 108 from where the HFA command 508 was received by the WMS 114. Thereafter, the HFA service system 108 sends this notification 518 confirming the completion of the manual task included in the HFA request 504 to the application 502 from where the HFA request 504 was first generated, thereby enabling the closed-loop operation.

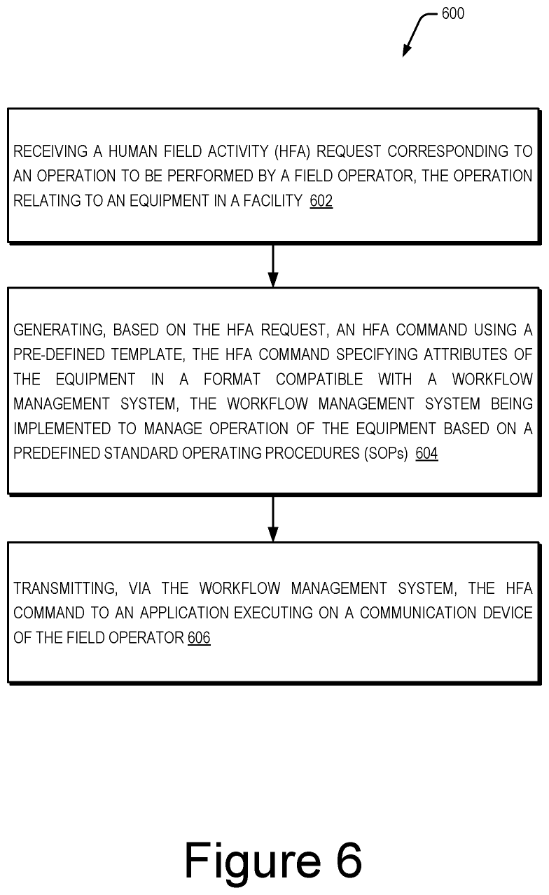

FIG. 6 illustrates a method 600 for communicating an HFA request to a field operator in a facility, in accordance with an example implementation of the present subject matter. Although the method 600 and may be implemented in a variety of computer-based systems, for the ease of explanation, the present description of the example method 600 to communicate the HFA request is provided in reference to the above-described HFA service system 108.

The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that blocks of the method 600 may be performed by programmed computing devices. The blocks of the method 600 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 6, at block 602, an HFA request, such as the HFA request 112 corresponding to an operation to be performed by a field operator, such as the field operator 206, on at least one equipment, such as the equipment 104-1, in a facility, such as the facility 102, is received. In an example, the HFA request 112 may be received by the HFA collector module 412 of the HFA service system 108. The operation may involve one or more tasks that the field operator 206 may need to perform in relation to the equipment 104-1 in the facility 102. For instance, an HFA request to set pressure in a pipeline to a certain value may involve tasks, such as actuating a series of pumps and valves associated with the pipeline in conjunction with reading and recording measurement of pressure from pressure gauges associated with the pipeline.

At block 604, based on the HFA request 112, an HFA command, such as the HFA command 508 as described in reference to FIG. 5, may be generated using a template. As previously explained, based on the operation and/or the equipment 104-1 to which the HFA request 112 was received at block 602, the HFA collector module 412 may select the template from a library of predefined templates that stores predefined templates corresponding to various HFA requests that may be handled by the HFA service system 108 in the facility 102.

The HFA command, generated at block 604, specifies the attributes of the equipment 104-1 in a format compatible with a workflow management system, such as the WMS 114, that manages the SOPs of the facility 102. Thus, the HFA command is readable by a device that communicates with the WMS 114, for instance, to receive instructions to carry out operations based on the HFA request 112. For example, the HFA command may be readable by a communication device, such as the communication device 116-1 of the field operator 206, executing a client application of the WMS 114. At block 606, the HFA command generated at block 604 is transmitted to the communication device 116-1 of the field operator 206.

Thus, the example method 600 to communicate the HFA request to the communication devices of the field operators may provide for HFAs of the facility to be performed without the intervention of control room operators.

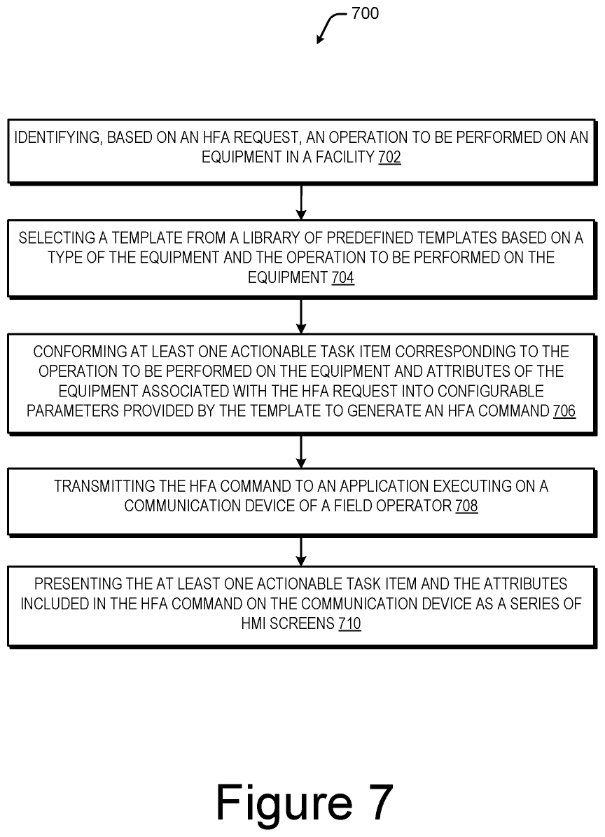

FIG. 7 illustrates a method 700 for communicating an HFA request to a field operator in a facility, in accordance with another example implementation of the present subject matter. Although, the method 700 may be implemented in a variety of computer-based systems, as is the case with method 600, for ease of explanation, the method 700 is described in reference to the above-described HFA service system 108.

The method 700 may be implemented by a processor(s) or computing device(s) through any suitable hardware, non-transitory machine-readable instructions, or a combination thereof. It may be understood that blocks of the method 700 may be performed by programmed computing devices such as the HFA service system 108. The blocks of the method 700 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media.

As discussed previously, in an example, the HFA collector module 412 of the HFA service system 108 may receive an HFA request, such as the HFA request 112, 504, from an application implemented at any network level in a facility, such as the facility 102. In an embodiment, the HFA request 112 may be received from the MMA 502 of the facility 102. The MMA 502 may be a software system configured to manage the movement of materials, products, and equipment's throughout the facility 102, as discussed above.

Referring to FIG. 7, at block 702, the HFA collector module 412 parses the HFA request 112 to identify one or more equipment's 104-1, 104-2 . . . , 104-n of the facility 102 to which the HFA request pertains and the operation to be performed on the equipment by a field operator, such as the field operator 206. In an example, the HFA request 112 may be indicative of at least one actionable task item pertaining to the operation to be performed by the field operator 206 on the equipment and attributes of the equipment. For instance, in an oil refinery, a valve may need to be closed by a field operator in real-time to transfer crude from ship A to tank B. For doing so, an HFA request may be submitted at the HFA service system 108 specifying an actionable task item of closing the valve and attributes of the valve, such as geolocation of the valve in the oil refinery, identification of the valve, etc.

Once the HFA request 112 is parsed to identify the equipment and operation to be performed on the equipment, the method 700 proceeds to block 704. At block 704, the HFA collector module 412 selects a template that corresponds to the HFA request 112 from a library of predefined templates that stores predefined templates corresponding to various HFA requests that may be handled by the HFA service system 108 in the facility 102.

In an example, the HFA collector module 412 selects the template based on the equipment to which the HFA request pertains. As explained previously, the library of predefined templates may be created such that a separate set of templates exists for a given type of equipment. For example, types of equipment's 104-1, 104-2 . . . , 104-n in the facility 102 that may require manual operation may be pumps, values, manual switches, etc. A template may be created for each of such equipment and may be searchable using the type of the equipment. For an operation involving a plurality of such equipment's, a corresponding template may be searched in the library of predefined templates based on a type of each of the one or more equipment's installed in the facility 102. The template comprises configurable parameters that may be configured to specify at least one actionable task item pertaining to the operation to be performed on the equipment and attributes of the equipment in the format that is compatible with the WMS 114.

At block 706, the HFA collector module 304 generates an HFA command by conforming the HFA request 112 to the template selected corresponding to the HFA request 112 at block 704. To conform the HFA request 112 to the selected template, the HFA collector module 304 configures the at least one actionable task item pertaining to the operation and attributes of the equipment into the configurable parameters of the selected template. For instance, for the HFA request corresponding to closing the valve in the oil refinery, the HFA collector module 304 may configure “close valve” as the actionable task item in a respective configurable parameter of the selected template. Similarly, identification of the valve, for example, valve number “V7034” may be configured as one of the attributes of the valve in a configurable parameter of the selected template that captures the attributes of the equipment.

At block 708, the HFA collector module 304 transmits the HFA command, via the WMS 114, to a client application executing on a communication device, such as the communication device 116-1 of the field operator 206. The HFA command specifies the at least one actionable task and the attributes of the equipment in a format that is compatible with the WMS 114.

At block 710, the at least one actionable task item to be performed on the equipment and the attributes of the equipment which are included in the HFA command are presented on the communication device 116-1 as a series of HMI screens to guide the field operator 206 on the operation. For instance, the field operator 206 may receive a request to close a valve numbered V7034 on his communication device. An example HMI screen may present instructions, for example, in the form of pictorial representations, to close the valve V7034.

In an example embodiment, the client application executing on the communication device 116-1, 116-2, 116-3 of the field operator 206 may include additional functionalities to ensure the field operator 206 is operating the correct equipment. For instance, for confirming that the field operator 206 is operating on the equipment for which an HFA request is received, the client application may provide a prompt requiring the field operator 206 to scan an NFC, barcode, or QR code that may be available on the equipment. In another example embodiment, a high-resolution picture of the equipment may be prompted by the client application to enable the field operator 206 to identify the correct equipment.

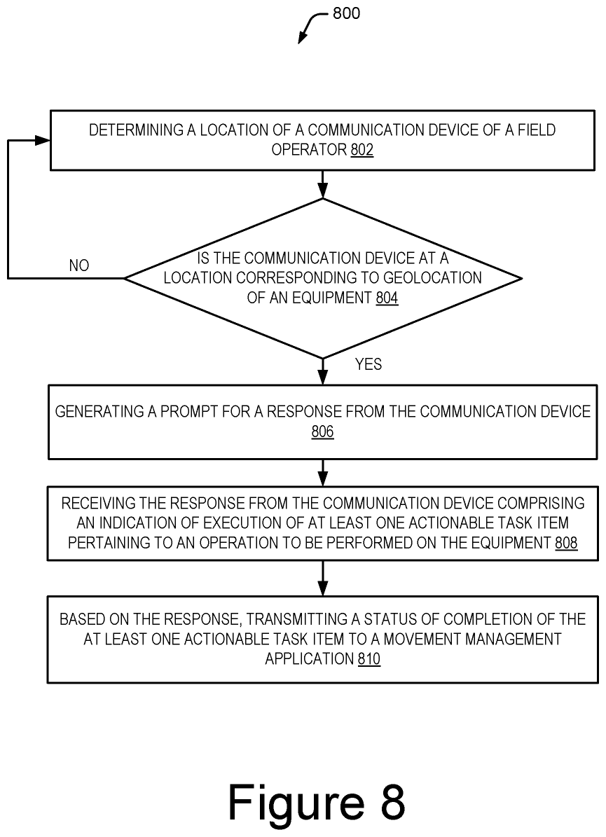

FIG. 8 illustrates a method 800 for indicating status of an HFA command, in accordance with an implementation of the present subject matter. In an embodiment, the method 800 for indicating the status of the HFA request 112, comprises steps that may, in any sequence or combination, be carried out in addition to the steps mentioned in the above-described method 700 for communicating the HFA request 112 to the field operator 206.

Although the method 800 for indicating status of the HFA request 112 may be performed by any computing system, for the ease of explanation, the method 800 is herein explained in reference to the HFA service system 108. Accordingly, in the examples provided in reference to method 800, the HFA collector module 412 of the HFA service system 108 may perform the steps of the method 800.

Referring to FIG. 8, at block 802, a location of the communication device 116-1 of the field operator 206 is determined. For example, the location of the communication device 116-1 may be determined by accessing a ground positioning module of the communication device 116-1 by the HFA service system 108. In another example, the location of the communication device 116-1 may be determined by enquiring the communication device 116-1 of its current location.

At block 804, it is determined whether the communication device 116-1 is at the geolocation of the equipment. If not, the process mentioned in block 802 is repeated. In an example, to enable the field operator 206 to reach to the geolocation of the equipment to complete the actionable task item associated with the equipment as specified in the HFA command, a location of the equipment may be indicated on a map of the facility. The location of the communication device 116-1 of the field operator 206 may also be tracked on the map.

At block 806, upon determining that the communication device 116-1, is at the geolocation of the equipment, a prompt may be generated on the communication device 116-1. The prompt may cause the field operator 206 to update the status of completion of the HFA command received corresponding to performing the at least one actionable task on the equipment.

At block 808, the field operator 206 may provide a response regarding the status of the completion of the HFA command in response to the prompt. The response is received at the WMS 114.

At block 810, based on the response received from the communication device 116-1, a notification of completion of the HFA request 112 is sent to the MMA 502 from where the HFA request 112 was originally received, thus completing a closed loop operation. For instance, when the field operator completes the actionable task of closing the valve V7034 and updates the status of the same through the communication device, results of the completion of the HFA request corresponding to valve V7034 may be automatically uploaded to the WMS 114. The HFA collector module 412 HFA of the service system 108 may receive this information from the WMS 114 and update the HFA request status to the MMA 502 which originally submitted the HFA request. The MMA 502 may change the state of the valve from open to closed.

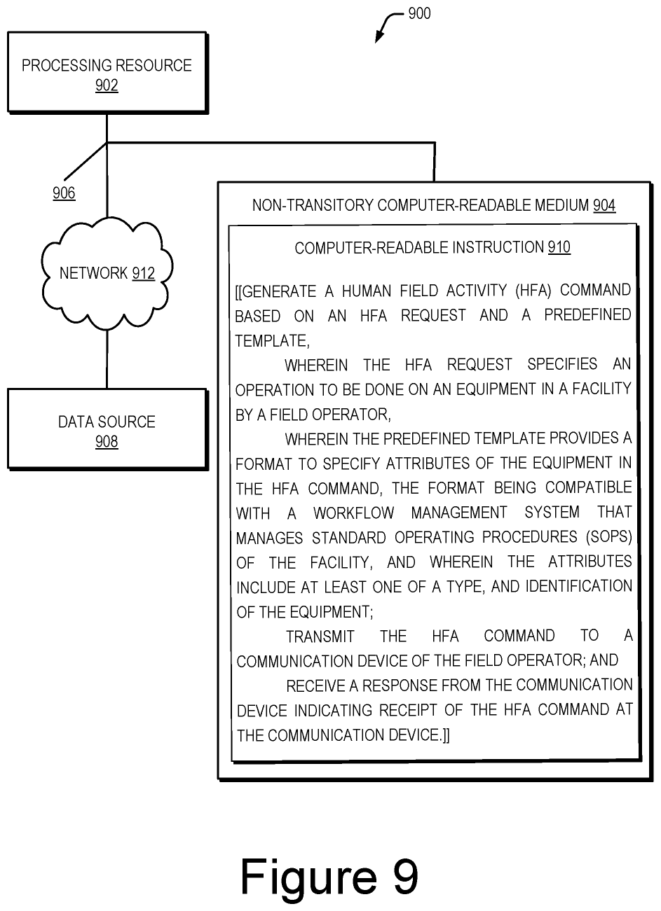

FIG. 9 illustrates a computing environment 900 for providing an HFA request 112 corresponding to an operation to be performed on an equipment of the facility 102, according to an example. The computing environment 900 includes a processing resource 902 communicatively coupled to a non-transitory computer-readable medium 904 through a communication link 906. In an example, the processing resource 902 may be the processor of the HFA service system 108, which fetches and executes computer-readable instructions from the non-transitory computer-readable medium 904.

The non-transitory computer-readable medium 904 may be, for example, an internal memory device or an external memory device. In an example implementation, the communication link 906 may be a direct communication link, such as any memory read/write interface. In another example implementation, the communication link 906 may be an indirect communication link, such as a network interface. In such a case, the processing resource 902 may access the non-transitory computer-readable medium 904 through a network 912. The network 912 may be a single network or a combination of multiple networks and may use a variety of different communication protocols.

The processing resource 902 and the non-transitory computer-readable medium 904 may also be communicatively coupled to data sources 908. The data source(s) 908 may be used to store data corresponding to the HFA request 112 corresponding to an operation to be performed on the equipment, such as the equipment 104-1, of the facility 102, for example.

In an example implementation, the non-transitory computer-readable medium 904 comprises executable instructions 910 for generating an HFA command based on an HFA request 112 and a template. In an example, the HFA request 112 may specify an operation to be performed on an equipment 104-1 in the facility 102 by a field operator 206.

In an example, the template provides a configurable format to specify attributes of the equipment in the HFA command. The format may be compatible with a WMS 114 that manages transmission of HFA command to a communication device, such as the communication device 116-1. In yet another example, the attributes may include type and identification of the equipment 104-1.

In an example, the instructions 910 cause the processing resource 902 to transmit the HFA command via the WMS 114 to the communication device 116-1 of the field operator 206. The HFA command may include at least one actionable task item and attributes, such as a geolocation of the equipment 104-1 in the facility 102, pertaining to the operation to be performed by the field operator 206 on the equipment 104-1, as previously explained.

In an example, the instructions 910 cause the processing resource 902 to receive a response from the communication device 116-1 indicating receipt of the HFA command on the communication device 116-1.

In another example, the instructions 910 cause the processing resource 902 to present the at least one actionable task item and attributes included in the HFA command as a series of HMI screens on the communication device 116-1 of the field operator 206.

As mentioned previously, using the communication device 116-1 the field operator 206 may provide a notification of completion of the HFA command 112 which is then transmitted to a source from where the HFA request 112 was originally received, such as the MMA 502, to allow the process to move further, thus enabling a closed-loop operation.

Thus, the methods and systems of the present subject matter address the need for applications that require HFAs to be processed on demand or in real-time. For each individual equipment, the HFA command is processed, and the status is communicated back immediately to the requesting application thus closing the loop and allowing the application to proceed with the requested action, thereby enabling on demand processing of the HFAs. This also helps in reducing the need for the control room operator to get involved in executing the operation which is not automated or arises out-of-turn in an industrial facility. This may result in considerable labor savings and may also reduce errors due to miscommunication between the field operator and the control room operators. Although implementations to provide an HFA request directly to the field operator without intervention in the industrial facility have been discussed in a language specific to structural features and/or methods, it is to be understood that the appended claims are not necessarily limited to the specific features or methods discussed. Rather, the specific features and methods are disclosed as example implementations for providing the HFA request to the field operators in an industrial facility.

What is claimed is:

1. A method, comprising:
receiving a human field activity (HFA) request corresponding to an operation to be performed by a field operator, the operation relating to at least one equipment in a facility;
generating, based on the HFA request, an HFA command using a template, the HFA command specifying attributes of the at least one equipment in a format compatible with a workflow management system, the workflow management system being implemented to manage operation of the at least one equipment based on a predefined standard operating procedures (SOPs); and
transmitting, via the workflow management system, the HFA command to an application executing on a communication device of the field operator.

2. The method of claim 1, wherein the HFA command comprises at least one actionable task item pertaining to the operation to be performed by the field operator on the at least one equipment.

3. The method of claim 2, wherein the at least one actionable task item and the attributes are depicted on the communication device as a series of HMI screens to guide the field operator on the operation to be performed on the at least one equipment.

4. The method of claim 1 further comprising:
receiving a response from the communication device of the field operator, the response comprising an indication of execution of the HFA command, and
based on the response, transmitting a status of completion of the HFA command to an application from where the HFA request is received.

5. The method of claim 4, further comprising generating a prompt for the response from the communication device of the field operator.

6. The method of claim 1, wherein the HFA request is received from an application at network level 1 through network level 3 of a network implemented in the facility.

7. The method of claim 1, further comprising;
detecting the communication device to be unavailable to receive the HFA command; and
queuing the HFA command until the communication device is available for receiving the HFA command.

8. The method of claim 1, wherein the attributes include at least one of a type, geolocation, and identification of the at least one equipment.

9. The method of claim 1, further comprising selecting, based on the attributes of the at least one equipment and the operation to be performed on the at least one equipment, the template from a library of predefined templates.

10. A human field activity (HFA) service system, comprising:
one or more processors;
a human field activity (HFA) collector module coupled to the one or more processors, wherein the HFA collector module is configured to:
identify, based on an HFA request, an operation to be performed by a field operator on an equipment in a facility;
select, based on the HFA request, a template from a library of predefined templates, the template comprising configurable parameters readable by a workflow management system, wherein the workflow management system is implemented to manage operation of the equipment based on a predefined standard operating procedures (SOPs) of the facility;
generate an HFA command by conforming at least one actionable task item specifying an action involved in the operation and attributes of the equipment associated with the HFA request into the configurable parameters of the template; and
a communication module coupled to the one or more processors, wherein the communication module is configured to transmit the HFA command to a client of the workflow management system accessible by the field operator.

11. The system of claim 10, wherein the HFA collector module is to select the template, from the library of predefined templates, based on a type of the equipment and the operation to be performed on the equipment.

12. The system of claim 10, wherein the communication module is further to present the at least one actionable task item and the attributes as a series of HMI screens displayable by the client of the workflow management system.

13. The system of claim 10, wherein the HFA collector module is configured to receive the HFA request from a source at any network level of a network implemented in the facility.

14. The system of claim 10, wherein the configurable parameters include at least one of a geolocation of the equipment and identification of the equipment.

15. The system of claim 10, wherein the communication module is to further:
receive a response from the client of the workflow management system, the response comprising an indication of execution of the HFA command, and
based on the response, update a status of completion of the HFA command at the workflow management system, wherein workflow management system is to further update the status at the source.

16. The system of claim 15, wherein the communication module is further to generate a prompt for the response from the client.

17. A non-transitory computer-readable medium comprising instructions executable by a processing resource to:
generate a human field activity (HFA) command based on an HFA request and a template,
wherein the HFA request specifies an operation to be done on an equipment in a facility by a field operator,
wherein the template provides a format to specify attributes of the equipment in the HFA command, the format being compatible with a workflow management system that manages standard operating procedures (SOPs) of the facility, and wherein the attributes include at least one of a type, and identification of the equipment;
transmit the HFA command to a communication device of the field operator; and
receive a response from the communication device indicating receipt of the HFA command at the communication device.

18. The non-transitory computer-readable medium as claimed in claim 17 further comprising instructions executable by the processing resource to specify at least one actionable task item corresponding to the operation in the HFA command.

19. The non-transitory computer-readable medium as claimed in claim 18 further comprising instructions executable by the processing resource to present the at least one actionable task item and the attributes as a series of HMI screens on the communication device.

20. The non-transitory computer-readable medium as claimed in claim 17 further comprising instructions executable by the processing resource to specify geolocation of the equipment, picture of the equipment, distance of the equipment from a current GPS position of the field operator in the facility as one of the attributes of the equipment in the HFA command.
